(19) United States
(12) Patent Application Publication
(10) Pub. No.: US 2011/0241567 A1
(43) Pub. Date: Oct. 6, 2011

(54) HYBRID FLOURESCENT LIGHT CONTROLLER

(75) Inventors: Mark Covaro, Sonoma, CA (US); Robert Henig, Palo Alto, CA (US); Amro A. Younes, Redwood City, CA (US)

(73) Assignee: REDWOOD SYSTEMS, INC., Fremont, CA (US)

(21) Appl. No.: 12/753,376

(22) Filed: Apr. 2, 2010

(51) Int. Cl. H05B 41/36

(52) U.S. Cl. 315/297

(57) ABSTRACT

A system may be provided for controlling an amount of light generated by multiple fluorescent lamps based on a desired light level. A dimming circuit may vary the amount of light generated by at least one of the fluorescent lamps based on the desired light level if the desired light level is in a first range of light level values. The fluorescent lamps remain lit as the amount of light generated by the lamps is varied. A switch circuit may switch off a first subset of the fluorescent lamps while a second subset of the fluorescent lamps remains lit if the desired light level is in a second range of light level values. The second range of light level values indicates less light is desired than the first range of light level values indicates.

### BACKGROUND

1. Technical Field

This application relates to lighting and, in particular, to control of light levels.

2. Related Art

The brightness of fluorescent lamps may depend on the amount of current flowing through the lamp. Fluorescent lamps may be dimmed using dimmable fluorescent lamp ballasts. A dimmable fluorescent lamp ballast controls the amount of current flowing through the fluorescent lamp based on a dimming signal.

In one example, the dimming signal may be a direct current (DC) signal. The brightness of the fluorescent lamp may depend, for example, on the voltage of the DC signal. The lower the voltage of the dimming signal, the less current flows through the fluorescent lamp and the less bright the lamp becomes. In a second example, the ballast may read a chopped line signal with an SCR (silicon controlled rectifier) based dimmer or a TRIAC (triode for alternating current) based dimmer. In a third example, the ballast may read a digital signal that conforms to a standard, such as RS-232, RS-485, DALI (Digital Addressable Lighting Interface), or any other suitable interface.

Fluorescent lamps do not operate properly if the current flowing through the lamp drops below a threshold value. For example, the lamps may flicker. Therefore, fluorescent lamps do not use the entire range of the dimming signal. For example, if the ballast is controlled by the voltage of a DC dimming signal, as the voltage of the dimming signal decreases, the ballast may decrease the current flowing through the fluorescent lamp until the voltage of the dimming signal reaches approximately two volts. If the voltage of the dimming signal drops below two volts, the current flowing through the fluorescent lamp may remain relatively constant. Accordingly, ballasts may clamp input nodes that receive the dimming signal at two volts in order to prevent the fluorescent lamps from malfunctioning. Consequently, the dimmable fluorescent lamp ballasts do not enable dimming of fluorescent lamps across the full range of a dimming signal.

### SUMMARY

A system may be provided that controls the amount of light generated by multiple fluorescent lamps based on a desired light level. The system may include a dimming circuit and a switch circuit. The dimming circuit may vary the amount of light generated by at least one of the fluorescent lamps based on the desired light level in response to a determination that the desired light level is within a first range of light level values. The fluorescent lamps remain lit as the amount of light is varied within the first range. The switch circuit may switch off a first subset of the fluorescent lamps while a second subset of the fluorescent lamps remains lit in response to a determination that the desired light level is within a second range of light level values. The second range of light level values indicates less light than the first range of light level values.

A light adapter may be provided that that controls the amount of light generated by multiple fluorescent lamps based on a desired light level. The light adapter may include a dimming circuit and a switch circuit. If a desired light level is in a first range of light level values, the dimming circuit may adjust the amount of light generated by the fluorescent lamps in accordance with the desired light level. The fluorescent lamps may be lit as the amount of light generated by the fluorescent lamps is varied. If the desired light level is in a second range of light level values, the switch circuit may be configured to switch off a first subset of the fluorescent lamps and switch on a second subset of the fluorescent lamps.

A method may be provided that controls an amount of light generated by fluorescent lamps based on a light level indicator. The amount of light generated by the fluorescent lamps may be altered when the light level indicator is in a first range of light level values. The fluorescent lamps may remain lit as the amount of light is altered. A first subset of the fluorescent lamps may be switched off by the light adapter in when the light level indicator is in a second range of light level values, while a second subset of the fluorescent lamps remains lit after the first subset of the fluorescent lamps is switched off. The second range of light level values indicates less light than indicated by the first range of light level values.

A system may also be provided that controls an amount of light generated by fluorescent lamps based on a desired light level. The system may include a light adapter, a first switch, and a second switch. The light adapter may be powered by a pulse width modulated signal received from an engine circuit over an adapter line. The desired light level may be indicated by a duty cycle of the pulse width modulated signal. The first switch may control whether at least a first one of the fluorescent lamps is on. The second switch may control whether at least a second one of the fluorescent lamps is on. The light adapter may include a switch circuit that is in communication with the first switch and the second switch. The switch circuit may switch the first switch off and the second switch on in response to a determination that the desired light level is less than a threshold light level. The switch circuit may switch both the first switch and the second switch on in response to a determination that the desired light level is not less than the threshold light level.

Further objects and advantages of the present invention will be apparent from the following description, reference being made to the accompanying drawings wherein preferred embodiments of the present invention are shown.

### BRIEF DESCRIPTION OF THE DRAWINGS

The embodiments may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 illustrates an example of a system for controlling fluorescent lamps;

FIG. 2 illustrates an example of a digital circuit implementation of a switch circuit in a light adapter;

FIG. 3 illustrates an example of a hardware diagram of the system for controlling fluorescent lamps that includes multiple light fixtures and corresponding light adapters;

FIG. 4 illustrates an example of a hardware diagram of the system for controlling fluorescent lamps and LED (light emitting diode) lamps; and

FIG. 5 illustrates an example flow diagram of logic for controlling fluorescent lamps.

### DETAILED DESCRIPTION

In one example, a light adapter includes a dimming circuit and a switch circuit. The light adapter may be in communication with two dimmable fluorescent lamp ballasts, each of which drives a corresponding one of two fluorescent lamps. The dimming circuit may be a circuit that generates a DC signal received by the two ballasts. The switch circuit may control two switches, such as two relays. Each one of the switches may open or close in response to a signal generated by the switch circuit, thereby preventing or enabling current flow through corresponding one of two fluorescent lamps. In another example, the control is built into the ballasts rather than being an adapter.

During operation of the light adapter, the light adapter may receive or determine a desired light level that indicates how much light should be generated by the two fluorescent lamps. The desired light level may also be referred to as a target light level. For example, the light adapter may receive a pulse-width modulated (PWM) signal that indicates the desired light level. The duty cycle of the PWM signal may correspond to the desired light level. For example, if the duty cycle is 100 percent, then the desired light level may correspond to 100 percent of the light that the two lamps are capable of generating. If the duty cycle is 50 percent, then the desired light level may correspond to 50 percent of the light the two lamps may generate. If the duty cycle drops below a minimum threshold, such as five percent, then the desired light level may be no light at all.

The dimming circuit may provide a dimming signal to both of the dimmable fluorescent lamp ballasts. For example, the dimming circuit may include a combination of an integrator and a sample-and-hold circuit that averages the received PWM signal into to a DC signal. The voltage of the DC signal corresponds to the duty cycle of the PWM signal. The dimming circuit may provide the DC signal as the dimming signal to the ballasts. The same or different DC signal may be provided to the different ballasts.

In one example implementation, the ballasts may ignore any voltage of the dimming signal below two volts. To compensate for this, the switch circuit may detect whether the voltage of the DC signal is below one volt. If so, then the switch circuit may open one of the switches so that no more current flows through one of the two fluorescent lamps. Consequently, if the voltage of the DC signal is one volt or less, then the light generated by the combination of the two fluorescent lamps is half what is generated when the voltage of the DC signal is two volts because one of the two fluorescent lamps is switched off. The switch circuit may further detect whether the voltage of the DC signal is below 0.5 volts. If so, then the switch circuit may open the second one of the switches so that no current flows through the second of the two fluorescent lamps either. At that point, no light is generated by the fluorescent lamps.

Consequently, the light adapter may facilitate more control over the light level of the fluorescent lamps than the dimmable ballast provides. Furthermore, the light adapter may be remotely controlled. Where the light adapter is remotely controlled using the duty cycle of the PWM signal, the system may provide uniform and continuous control of the light level of the fluorescent lamps by varying the duty cycle. Thus, the system may provide smooth dimming control without noticeable abrupt changes in light levels. Moreover, varying the duty cycle of the PWM signal provides an effective use of limited communication bandwidth on an adapter line that carries the PWM signal to the light adapter.

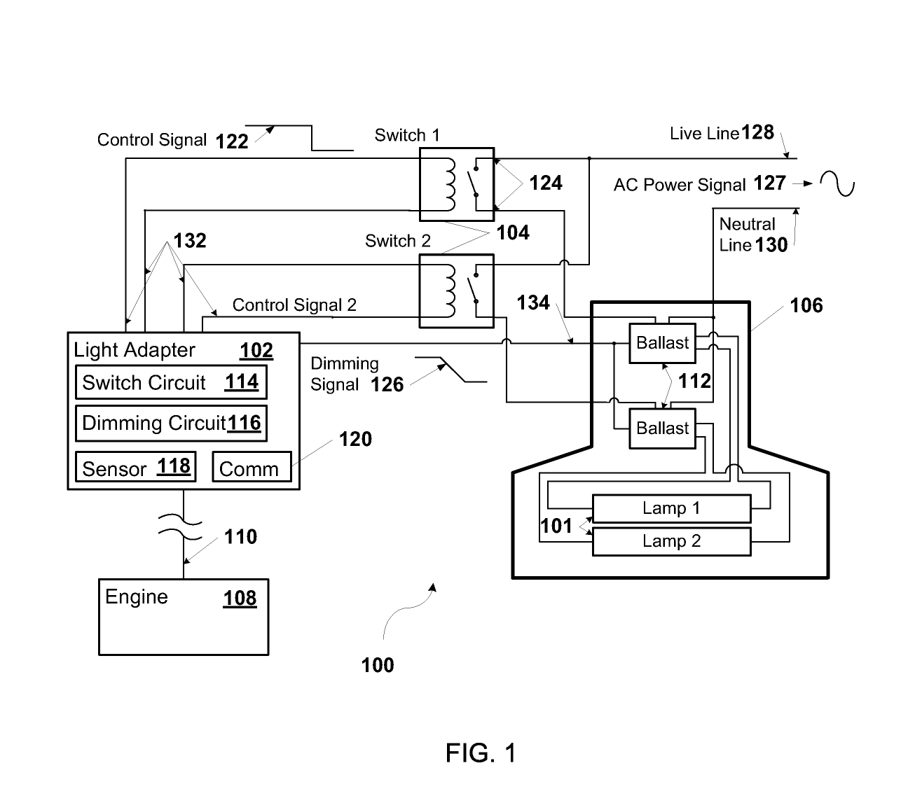

FIG. 1 illustrates an example of a system 100 for controlling fluorescent lamps 101. The system 100 may include a light adapter 102, switches 104, and a light fixture 106. The system 100 may include more, fewer, or different elements. In a first example, the system 100 may include multiple light fixtures instead of just the one light fixture 106. In a second example, the system 100 may include an engine circuit 108 that provides electrical power to, and is in communication with, the light adapter 102 over an adapter line 110. The engine circuit 108 may be referred to simply as the engine 108. In a third example, the system 100 may only include the light adapter 102.

The light fixture 106 may be any device or combination of devices that includes one or more fluorescent lamps 101. The light fixture 106 may additionally include one or more fluorescent lamp ballasts 112. Examples of the light fixture 106 include a compact fluorescent light, a task/wall bracket fixture, a linear fluorescent high-bay, a spot light, a recessed louver light, or any other unit that includes one or more fluorescent lamps 101.

Fluorescent lamps 101 may be any artificial light sources that generate light by sending an electrical discharge through an ionized gas. Examples of gases included in the fluorescent lamps 101 include mercury vapor, sodium vapor, argon, neon, or any other suitable gas.

Each one of the fluorescent lamp ballasts 112 may be any device operable to control the amount of current flowing through one or more fluorescent lamps 101. Examples of the fluorescent lamp ballasts 112 include a dimmable fluorescent lamp ballast, a fluorescent lamp ballast without dimming capabilities, an instant start ballast, a rapid start ballast, a programmed start ballast, any other suitable electric current limiting device, or any combination thereof. The term “ballast” may refer to any type of fluorescent lamp ballast.

Each one of the switches 104 may be any device or combination of devices that receives a control signal 122 and opens and closes an electrical connection between two or more nodes 124 based on the control signal 122. Examples of the switches 104 include a relay, a contactor, a semiconductor switch, a transistor, an opto-isolated switch, or any other electrical component that can break an electrical circuit by interrupting electric current between two nodes.

The light adapter 102 may be any device or combination of devices that selectively switches on or off, or otherwise controls, electrical current through the fluorescent lamps 101 to match the desired light level. The light adapter 102 may include a switch circuit 114, a dimming circuit 116, and a sensor 118. The light adapter 102 may include more, fewer, or different elements. For example, the light adapter 102 may include a communication circuit 120 that communicates with the engine 108 over the adapter line 110. Alternatively or in addition, the light adapter may not include the sensor 118. Alternatively or in addition, the light adapter 102 may not include the communication circuit 120. Alternatively or in addition, the light adapter 102 may not include the dimming circuit 116. For example, the light adapter 102 may include just the switch circuit 114.

The dimming circuit 116 may be any circuit that generates at least one dimming signal 126 based on the desired light level. The dimming signal 126 may be any signal that indicates to one or more of the ballasts 112 how much current is to flow through one or more of the fluorescent lamps 101 driven by the ballasts 112. The dimming signal 126 may be any signal compatible with any of the ballasts 112 controlled by the dimming signal 126. Examples of the dimming signal 126 include a zero to 10 volt DC signal, a chopped line signal for a SCR (silicon controlled rectifier) or a TRIAC (triode for alternating current) based dimmable fluorescent lamp ballast, a digital signal that conforms to a communications standard, such as RS-232, RS-485, or DALI (Digital Addressable Lighting Interface), or any other suitable signal.

In one example, the dimming circuit 116 may include a combination of an integrator and a sample-and-hold circuit that converts a PWM signal received over the adapter line 110 from the engine 108 into to a DC signal. The amplitude of the pulse portion of the PWM signal may remain constant. The duty cycle of the PWM signal may represent the desired light level. The combination of the integrator and the sample-and-hold circuit may generate the DC signal as the average current of the PWM signal. Thus, the higher the duty cycle of the PWM signal, the higher the voltage of the dimming signal 126. The dimming circuit may provide the DC signal as the dimming signal 126 to the ballasts 112.

In a second example, the dimming circuit 116 may communicate with the ballasts 112 by transmitting the desired light level to the ballasts 112 in at least one message that conforms to a communications protocol, such as DALI. The dimming signal 126 may comprise a message or messages that convey the desired light level.

The switch circuit 114 may be any circuit that controls at least one of the switches 104 based on the desired light level. For example, the switch circuit 114 may include an analog comparator and an element that averages the PWM signal received over the adapter line 110 from the engine 108. Alternatively or in addition, the dimming circuit 116 may include the element that averages the PWM signal received over the adapter line 110. The analog comparator may compare the average voltage of the PWM signal with a reference voltage. The output of the analog comparator may be the control signal 122 that controls one of the switches 104. The desired light level may be represented as the average voltage of the PWM signal. The reference voltage may correspond to a threshold value of the desired light level below which the switch receiving the control signal 122 is to open the circuit between the nodes 124 of the switch. The switch circuit 114 may be configured such that, when the average voltage of the PWM signal exceeds the reference voltage, the control signal 122 closes the switch. Conversely, when the average voltage of the PWM signal falls below the threshold voltage, the control signal 122 opens the switch.

The communication circuit 120 may be any circuit that communicates with the engine 108. The communication circuit 120 may receive data from the engine 108. Alternatively or in addition, the communication circuit 120 may transmit data to the engine 108. In one example, the communication circuit 120 may transmit sensor data obtained with the sensor 118 to the engine 108. In a second example, the communication circuit 120 may receive the desired light level from the engine 108. For example, the communication circuit 120 may receive frequency modulated information from the engine 108 by detecting the frequency of a PWM signal received over the adapter line 110.

The communication circuit 120 may communicate with the engine 108 using any method of communication now known or later discovered. Examples of the communication circuit 120 include a network interface card or any other component that facilitates communication over the network, such as a network protocol stack. The network may be a Local Area Network (LAN), a Wireless Local Area Network (WLAN), a Personal Area Network (PAN), a Wide Area Network (WAN), or any other now known or later developed communications network. The network may include the adapter line 110. The communication circuit 120 may provide physical access to the network and may provide a low-level addressing system through use of Media Access Control (MAC) addresses, or any other suitable protocol.

The engine 108 may be any device or combination of devices that may communicate with the light adapter 102, provide power to the light adapter 102, or any combination thereof. For example, the engine 108 may include one or more AC to DC (Alternating Current to Direct Current) converters used to supply current to one or more light adapters 102 over one or more adapter lines 110. The engine 108 may communicate with the light adapter 102 using any method of communication now known or later discovered. In one example, the engine 108 may supply power and communicate with the light adapter 102 over the single adapter line 110. In a second example, the light adapter 102 may be powered by some other source. The engine 108 may communicate with and supply power to the light adapter 102 as described in U.S. patent application Ser. No. 12/389,868, entitled “TRANSMISSION OF POWER AND DATA WITH FREQUENCY MODULATION” filed Feb. 20, 2009, the entire contents of which are incorporated herein by reference, U.S. patent application Ser. No. 12/536,231, entitled “DIGITAL SWITCH COMMUNICATION” filed Aug. 5, 2009, the entire contents of which are incorporated herein by reference, and U.S. patent application Ser. No. 12/465,800, entitled “DISCHARGE CYCLE COMMUNICATION” filed May 14, 2009, the entire contents of which are incorporated herein by reference.

The switch circuit 114, the dimming circuit 116, the communication circuit 120, or any combination thereof may be implemented as a digital circuit that comprises a processor and a memory. The memory may be any now known, or later discovered, data storage device or combination of data storage devices. The memory may include non-volatile and/or volatile memory, such as a random access memory (RAM), a read-only memory (ROM), an erasable programmable read-only memory (EPROM), or flash memory. Alternatively or in addition, the memory may include an optical, magnetic (hard-drive) or any other form of data storage device. The processor may be in communication with the memory. The processor may also be in communication with additional components, such as the switches 104. The processor may include a general processor, a central processing unit, a server, an application specific integrated circuit (ASIC), a digital signal processor, a field programmable gate array (FPGA), a digital circuit, an analog circuit, or combinations thereof. The processor may include one or more elements operable to execute computer executable instructions or computer code embodied in the memory to implement the functionality of the corresponding circuit, such as the functionality of the switch circuit 114, the dimming circuit 116, or the communication circuit 120. Each one of the circuits may include a corresponding processor and memory. Alternatively, two or more of the circuits may share the processor, the memory, or both. In one example, one or more of the circuits 114, 116, and 120 may be implemented as a digital circuit while the other circuit or circuits are implemented as analog circuits. In a second example, one or more of the circuits 114, 116, and 120 may be implemented using a combination of a digital circuit and an analog circuit. For example, the communication circuit 120 may measure widths and frequencies of pulses detected on a pair of conductors included in the adapter line 110. Analog circuitry may extract and condition the pulses to form digital signals that are further processed by the processor.

The sensor 118 may be any device that measures a physical characteristic and converts it into a signal. Examples of the sensor 118 include, but are not limited to, a motion detector, a photodetector, or any other suitable device. The light adapter 102 may include any number sensors.

In the example system 100 illustrated in FIG. 1, the fluorescent lamps 101 are powered by an alternating current (AC) power signal 127. A live line 128 and a neutral line 130 deliver the AC power signal 127 to the fluorescent lamps 101. Each one of the switches 104 and each one of the ballasts 112 may be connected in series with a corresponding one of the fluorescent lamps 101 so that the AC power signal 127 may flow through the switches 104 and the ballasts 112. In FIG. 1, there is a one-to-one correspondence between the switches 104, the ballasts 112, and the fluorescent lamps 101. Alternatively, any one of the switches 104 may be connected in series with two or more of the ballasts 112. Alternatively or in addition, any one of the switches 104 may be connected in series with two or more of the fluorescent lamps 101. Alternatively or in addition, any one of the ballasts 112 may supply the AC power signal 127, or a signal derived from the AC power signal 127, to two or more of the fluorescent lamps 101.

The light adapter 102 may deliver the control signals, such as the control signal 122, to the switches 104 over control lines 132. In one example, each one of the control signals may be delivered to a corresponding one of the switches 104. In a second example, any one of the control signals may be delivered to two or more of the switches 104.

The light adapter 102 may deliver one or more dimming signals, such as the dimming signal 126, over one or more dimming signal lines 134. There may be a one-to-one correspondence between dimming signal lines 134 and the ballasts 112. That is, each one of the dimming signal lines 134 may control a respective one of the dimming ballasts 112. Alternatively, one of the dimming signal lines 134 may be electrically coupled to two or more of the ballasts 112, as illustrated in FIG. 1.

Alternatively, the engine 108 instead of the light adapter 102 may provide one or more dimming signals, such as the dimming signal 126 over the adapter line 110. For example, the adapter line 110 may be electrically coupled to one or more of the ballasts 112. The dimming circuit 116 may be included in the engine 108 instead of in the light adapter 102. For example, the dimming circuit 116 may include an AC to DC converter that generates a suitable dimming signal 126.

During operation of the system 100, the light adapter 102 may control the electric current flowing through the fluorescent lamps 101 in order to produce the desired light level. The light adapter 102 may determine the desired light level. For example, the light adapter 102 may operate to maintain a total target light level in a physical space as sunlight in the physical space varies over time. The light adapter 102 may measure the light level in a physical space with the sensor 118. The light adapter 102 may then determine the desired light level of the fluorescents lamps 101 in order for the light level in the physical space to reach the total target light level. The light adapter 102 may repeatedly adjust the desired light level and measure the light level until the total target light level in the physical space is reached.

Alternatively or in addition, the light adapter 102 may receive the desired light level from a remote source, such as from the engine 108. For example, the light adapter 102 may receive a PWM signal from the engine 108 over the adapter line 110, where the duty cycle of the PWM signal corresponds to the desired light level. Alternatively, the light adapter 102 may receive the desired light level in any other suitable format. For example the light adapter 102 may receive a message encapsulated in one or more TCP/IP (transmission control protocol/Internet protocol) frames or in one or more packets formatted in accordance with some other protocol. The message received may include the desired light level. In other embodiments, the desired light level is provided from a manual input, such as a potentiometer.

In one embodiment, the engine 108 may control the electric current flowing through the fluorescent lamps 101 in order to produce the desired light level. The engine 108 may determine the desired light level. For example, the engine 108 may operate to maintain a total target light level in a physical space as sunlight in the physical space varies over time. The light adapter 102 may measure the light level in a physical space with the sensor 118. The light adapter 102 may transmit the measured light level to the engine 108. The engine 108 may then determine the desired light level of the fluorescents lamps 101 in order for the light level in the physical space to reach the total target light level. The engine 108 may repeatedly adjust the desired light level and receive the measured light level until the total target light level in the physical space is reached.

The desired light level may be represented using any method now known or later discovered. Examples of the desired light level include a number, a percentage, or symbol stored in the memory of the light adapter 102, a duty cycle of a PWM signal received at the light adapter 102, a voltage level of a DC signal, any other type of indicator or suitable encoding.

The light adapter 102 controls electric current flowing through the fluorescent lamps 101 in order to produce the desired light level, at least in part, by opening and closing the switches 104. Table 1 below illustrates one example of how the light adapter 102 may convert the desired light level into control signals for the switches 104 and into the dimming signal 126 for the dimmable fluorescent ballasts 112. Other step sizes or resolutions and/or voltage ranges may be used. Analog dimming signals may be used such that Table 1 represents samples along a continuum.

TABLE 1

| | Dimming | | |
|---|---|---|---|
| Desired Light Level (%) | Signal (Volts) | Switch 1 | Switch 2 |
| 20 < level < 100 | level/10 | Closed | Closed |
| 16 < level < 20 | 2 | Closed | Closed |
| 14 < level < 16 | 2 | Open | Closed |
| 11 < level < 14 | 2 | Closed | Open |
| 0 < level < 11 | 2 | Open | Open |

In the example illustrated in Table 1, the system 100 may include the light adapter 102, two switches 104, and two dimmable fluorescent ballasts 112 that drive three fluorescent lamps 101 in the light fixture 106. The single dimming signal line 134 may be electrically coupled to two dimmable fluorescent ballasts 112 that drive three fluorescent lamps 101. The dimmable fluorescent ballasts 112 accept the dimming signal 126 in the format of a DC signal that ranges from zero to 10 volts. The first ballast drives one of the fluorescent lamps 101. The second ballast drives two of the fluorescent lamps 101. The first switch is in series with the first ballast and the second switch is in series with the second ballast. As a result, if the first switch is opened, then one of the three fluorescent lamps 101 will switch off. If the second switch is opened, then the other two fluorescent lamps 101 will switch off.

The voltage of the dimming signal 126 may be a function of the desired light level. For example, the voltage may be the desired light level divided by 10. If the desired light level is 100 percent, then the light adapter 102 may provide a 10 volt DC dimming signal to both of the ballasts 112, indicating that the fluorescent lamps 101 are to be fully lit. Both switches 104 are closed so that the fluorescents lamps 101 may be powered by the ballasts 112. If the desired light level is lowered to 20 percent, then the light adapter 102 may provide a two volt dimming signal to the ballasts 112 indicating that the fluorescents lamps 101 should be dimmed. Both switches 104 remain closed so that both ballasts 112 continue to power the three fluorescents lamps 101, albeit with less current than if the dimming signal 126 were 10 volts.

In the example illustrated in Table 1, the ballasts 112 may clamp the dimming signal line 134 at a minimum voltage, such as two volts, in order to prevent the fluorescent lamps 101 from working improperly. Alternatively or in addition, the light adapter 102 may clamp the dimming signal line 134 at the minimum voltage. As a result, the light adapter 102 may not further dim the three fluorescent lamps 101 with the dimming signal 126. However, if the desired light level is between 14 and 16 percent, the light adapter 102 may switch off one of the fluorescent lamps 101 by opening the first of the two switches 104. The light adapter 102 may keep the second of the two switches 104 closed, so that the other two fluorescent lamps 101 remain on. Thus, when the desired light level is between 14 and 16 percent, the overall light generated by the fluorescent lamps 101 is two-thirds the overall light generated by the three fluorescent lamps 101 when the desired light level is between 16 and 20 percent. The dimming level of the lamps 101 still on may be adjusted to counteract the other lamp 101 being turned off, such as increasing the dimming signal to the lamp 101 remaining on when the other lamp 101 is turned off.

If the desired light level is between 11 and 14 percent, the light adapter 102 may switch off two of the fluorescent lamps 101 by opening the second of the two switches 104. The light adapter 102 may close the first of the two switches 104, so that just one of the fluorescent lamps 101 is on. Thus, when the desired light level is between 11 and 14 percent, the overall light generated by the fluorescent lamps 101 is one-third the overall light generated by the three fluorescent lamps 101 when the desired light level is between 16 and 20 percent.

If the desired light level is below 11 percent, then the light adapter 102 may switch off the three fluorescent lamps 101 by opening the two switches 104. Therefore, the combination of the switch circuit 114 and the dimming circuit 116 provide more control over the amount of light generated by the fluorescent lamps 101 than dimmable fluorescent lamp ballasts 112 alone provide.

Table 2 below illustrates a second example of how the light adapter 102 may convert the desired light level into control signals for the switches 104, where none of the ballasts 112 are dimmable fluorescent ballasts.

TABLE 2

| Desired Light Level (%) | State Number | Switch 1 | Switch 2 |
|---|---|---|---|
| 70 < level < 100 | 3 | Closed | Closed |
| 40 < level < 70 | 2 | Open | Closed |
| 10 < level < 40 | 1 | Closed | Open |
| 0 < level < 10 | 0 | Open | Open |

In the example illustrated in Table 2, the system 100 may include the light adapter 102, two switches 104, and two non-dimmable fluorescent ballasts 112 that drive three fluorescent lamps 101 in the light fixture 106. The first ballast drives one of the fluorescent lamps 101. The second ballast drives two of the fluorescent lamps 101. The first switch is in series with the first ballast and the second switch is in series with the second ballast. As a result, if the first switch is opened, then one of the three fluorescent lamps 101 is switched off. If the second switch is opened, then the other two fluorescent lamps 101 are switched off.

If the desired light level is between 70 and 100 percent, then the light adapter 102 may close the switches 104 so that the three fluorescent lamps 101 are all on. If the desired light level is between 40 and 70 percent, the light adapter 102 may switch off one of the fluorescent lamps 101 by opening the first of the two switches 104. Thus, when the desired light level is between 40 and 70 percent, the overall light generated by the fluorescent lamps 101 is two-thirds the overall light generated by the fluorescent lamps 101 when the desired light level is between 70 and 100 percent. If the desired light level is between 10 and 40 percent, the light adapter 102 may switch the first one of the fluorescent lamps 101 back on by closing the first of the two switches 104, and switch off the other two fluorescent lamps 101 by opening the second of the two switches 104. If the desired light level is less than 10 percent, then the light adapter 102 may switch off the three fluorescent lamps 101 by opening both of the switches 104.

Table 3 below illustrates a third example of how the light adapter 102 may convert the desired light level into control signals for two switches 104, where none of the ballasts 112 are dimmable fluorescent ballasts and each of the ballasts 112 drives the same corresponding number of fluorescent lamps 101. The combinations of the open and closed positions of the two switches 104 provide four possible states. Each of the states provides a corresponding light output level. The states are numbered zero to three in Table 3.

TABLE 3

| Desired Light Level (%) | State Number | Switch 1 | Switch 2 |
|---|---|---|---|
| 70 < level < 100 | 3 | Closed | Closed |
| 15 < level < 70 | 2 | Open | Closed |
| 15 < level < 70 | 1 | Closed | Open |
| 0 < level < 15 | 0 | Open | Open |

The light adapter 102 may open and close the switches 104 in accordance with either state number 1 or state number 2 if the desired light level is between 15 and 70 percent. Setting the switches 104 in accordance with either state number 1 or state number 2 directs the fluorescent lamps 101 to generate the same amount of overall light output, regardless of whether state number 1 or state number 2 is used. In one example, the light adapter 102 may alternate between using state number 1 and state number 2 when the light adapter 102 first detects the desired light level falls in the range of 15 to 70 percent. As long as the desired light level remains in the range of 15 to 70 percent, the light adapter 102 may continue to use the selected state number. Alternating between using state number 1 and state number 2 may reduce the number of times any one of the ballasts 112 or fluorescent lamps 101 switches on and off. This may increase the overall life of the system 100.

The numbers and thresholds described above are merely examples provided for illustrative purposes. Other numbers and thresholds may be used. The system 100 may include alternative implementations.

For example, the light adapter 102 may power the fluorescent lamps 101 instead of the fluorescent lamps 101 being powered by the AC power signal 127 provided over the live line 128 and the neutral line 130. The engine 108 may convert AC to DC and include a current source that powers both the light adapter 102 and the fluorescent lamps 101 over the adapter line 110. Alternatively, the adapter line 110 may transport the AC power signal 127 to the fluorescent lamps 101. The light adapter 102 may also be powered from the AC power signal 127 on the adapter line 110.

Fluorescent ballasts available for purchase today, dimmable or otherwise, may not include a switch that completely shuts off flow to a fluorescent lamp powered by the ballast. Instead, a wall switch or a motion sensor breaks the AC signal flowing through the ballasts and the fluorescent lamp. Any of the ballasts 112 may be modified to include one or more of the switches 104. Alternatively or in addition, any of the ballasts 112 may be modified to switch off the current to any of the fluorescent lamps 101 powered by the ballast if the dimming signal 126 indicates the desired light level is lower than a minimum threshold level. If the dimming signal 126 may operate to switch off the current to the fluorescent lamps 101, then the dimming signal line 134 effectively may operate as a corresponding one of the control lines 132. The fluorescent lamps 101 and the ballasts 112 may each be included in separate light fixtures 106.

In one example, the light adapter 102 may be included in the light fixture 106. Alternatively or in addition, the light adapter 102 may be included in one or more of the ballasts 112. In other embodiments, the light adapter 102 is included in a switch box or in another suitable location external to the ballasts.

In one embodiment, the light adapter 102 may determine what types of ballasts are in the system 100. Alternatively or in addition, the engine 108 may determine what types of ballasts are in the system 100. For example, the engine 108 may receive user input indicating the type of ballast included in the light fixture 106 and transmit an indication of the type of ballast to the light adapter 102. Alternatively or in addition, the engine 108 may receive user input indicating the type of light fixture that is in use. In one example, the light adapter 102 or the engine 108 may determine the type of ballast from the type of light fixture. The light adapter 102 may transmit the type of light fixture and/or the type of ballast to the engine 108. Alternatively or in addition, the light adapter 102 may provide one type of dimming signal to the ballasts 112 and determine from the sensor 118 whether the dimming signal 126 modified the light generated by the fluorescent lamps 101. The light adapter 102 may repeat until an appropriate dimming signal 126 is found. If no appropriate dimming signal 126 is found, the light adapter 102 may treat the ballasts 112 as non-dimmable.

Variances in the components of the system 100 may result in behavioral differences in the components. Accordingly, the engine 108 may calibrate the system 100 to determine suitable ranges, suitable control signals properties, or any other values, such as the ranges listed in Tables 1-3. For example, the engine 108 may vary the duty cycle of the PWM signal on the adapter line 110 until a particular light level is generated at the light fixture 106. While the engine 108 varies the duty cycle of the PWM signal, the light adapter 102 may receive the measured light level from the sensor 118 and transmit the measured light level to the engine 108. The engine 108 may compare the measured light level to the duty cycle of the PWM signal. In the example illustrated in Table 2, the light level changes when the desired light level drops below or raises above 70 percent, 40 percent, and 10 percent, respectively. By varying the duty cycle of the PWM signal and receiving the corresponding measured light level, the engine 108 may determine what duty cycles correspond to the 70 percent, 40 percent, and 10 percent threshold levels. The corresponding duty cycles may not be exactly 70 percent, 40 percent, and 10 percent due to, for example, component variances. After determining the corresponding duty cycles, the engine 108 may generate the PWM signal with a suitable duty cycle in order to obtain the desired light level 208. Alternatively or in addition, the engine 108 may vary the duty cycle of the PWM signal until a measured voltage of the dimming signal 126 matches a desired voltage or set of voltages.

Alternatively or in addition, the light adapter 108 may perform the calibration. For example, the light adapter 102 may measure the pulse width of the PWM signal and measure the resulting voltage of the dimming signal 126, which may, in one example, be configured to range between zero and 10 volts DC. The light adapter 102 may determine a constant value based on a ratio of the pulse width of the PWM signal and the resultant voltage of the dimming signal 126. The light adapter 102 may store the constant value in the memory of the light adapter 102. Alternatively or in addition, the engine 108 may store the constant value in the memory of the engine 108. The light adapter 102 and or the engine 108 may determine multiple constant values by repeatedly comparing the duty cycle with the voltage of the dimming signal 126. Using one or more of the constant values, the light adapter 102, the engine 108, or any combination thereof may determine a suitable pulse width of the PWM signal in order to obtain a desired voltage of the dimming signal 126. The engine 108 and the light adapter 102 may communicate with each other in order to complete the calibration. For example, if an 8 Volt dimming signal 126 is requested at the engine 108 by setting a particular duty cycle, the engine 108 may receive an actual measurement of the voltage of the dimming signal 126 from the light adapter 102 in order to determine whether the dimming signal 126 actually is 8 Volts.

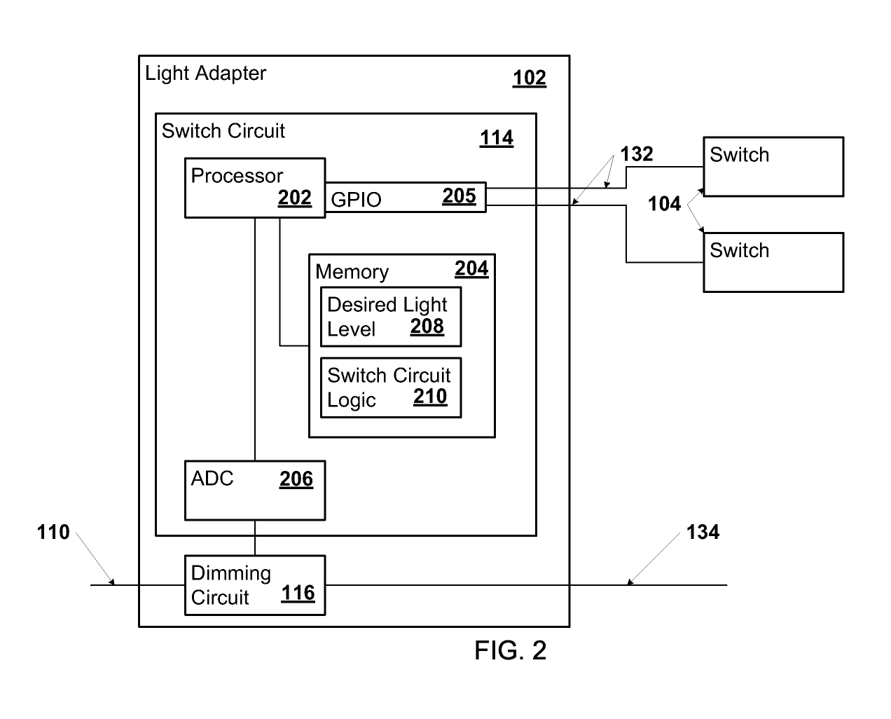

FIG. 2 illustrates an example of a digital circuit implementation of the switch circuit 114 in the light adapter 102. The switch circuit 114 may include the processor 202, the memory 204, and an ADC (analog-to-digital converter) 206. The switch circuit 114 may include different, additional, or fewer elements. For example, the switch circuit 114 may include one or more opto-isolator switches.

The processor 202 may be in communication with the memory 204, the ADC 206, and the switches 104. For example, the processor 202 may be in communication with the switches 104 over a GPIO (general purpose I/O bus) 205 where the control lines 132 are electrically coupled to the GPIO 205.

The ADC 206 may convert an analog signal, which has a voltage and/or current corresponding to the desired light level 208, into a digital value. For example, the ADC 206 may receive the dimming signal 126 from the dimming circuit 116. The processor 202 may read the desired light level 208 from the ADC 206.

Alternatively or in addition, the ADC 206 may receive the PWM signal over the adapter line 110. The processor 202 may process the digitized PWM signal received from the ADC 206. In one example, the processor 202 may determine the desired light level 208 from the duty cycle of the digitized PWM signal. In a second example, the processor 202, during the calibration discussed above, may determine the constant value or values by determining the duty cycle of the PWM signal digitized by the ADC 206 and comparing the duty cycle with the voltage of the dimming signal 126 read from the ADC 206.

Alternatively or in addition, the ADC 206 may receive other analog signals. For example, the ADC 206 may convert one or more signals received from the sensor 118.

The processor 202 may store the desired light level 208 in the memory 204. The desired light level 208 may be determined at the light adapter 102, be received from the engine 108, or be received from any other source. The processor may also store a measured light level, received from the sensor 118, in the memory 204. The processor 202 may evaluate the desired light level 208 to determine whether the switches 104 are to be open or closed. For example, the processor 202 may determine whether the desired light level 208 falls within a particular range of values as described above. The processor 202 may set or reset digital pins on the GPIO 205 that correspond to the control signal lines 132. In response, each one of the switches 104 may open or close based on whether the corresponding digital pins are high or low. The processor 202 may adjust the range of values so that component and circuit tolerances may be removed or reduced. The logic that the processor 202 executes in order to carry out the operations of the switch circuit 114 may be stored in the memory 204 as switch circuit logic 210.

In an alternative example, the ADC 206 may be included in an Integrated Circuit (IC) that also includes opto-isolator switches. The processor 202 may be in communication with the opto-isolator switches via the one or more pins on the GPIO 205. Each one of the opto-isolator switches may be electrically coupled to a corresponding one of the control signal lines 132. In a first example, each one of the pins on the GPIO 205 may correspond to one of the control signal lines 132. In a second example, one of the pins on the GPIO 205 may be used to serially communicate with the IC in order to specify the states of the control signal lines 132. The IC may set the states on the control signal lines 132 by opening and/or closing the opto-isolator switches based on the serial communication. Alternatively or in addition, the opto-isolated switches may not be included in the IC.

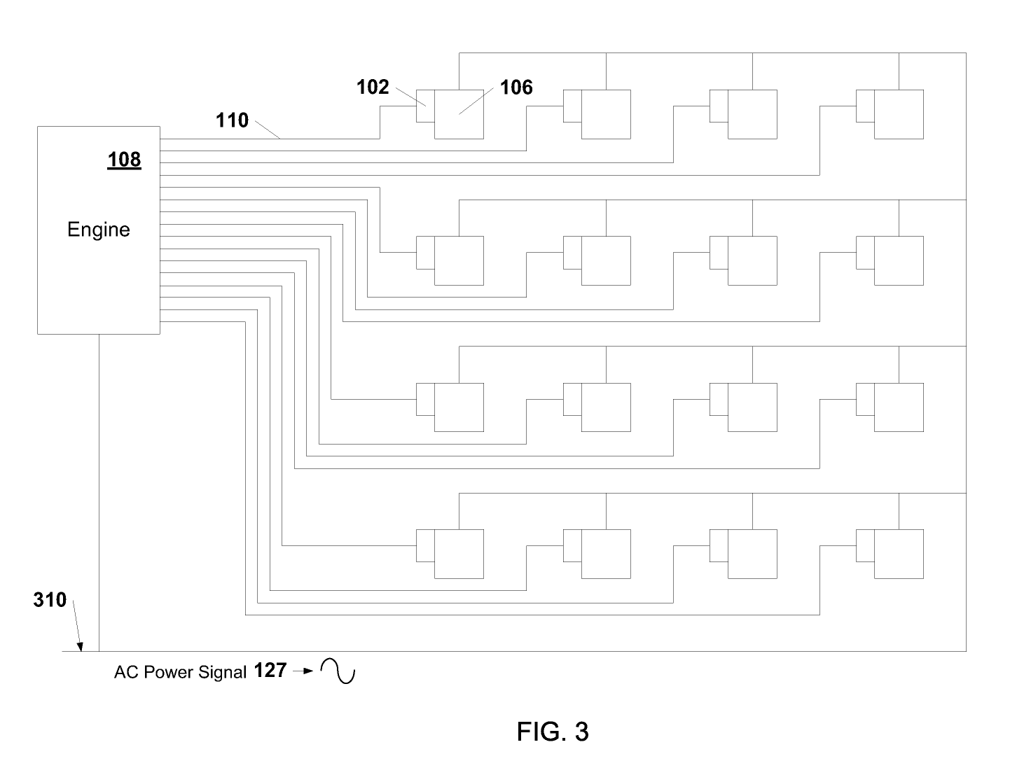

FIG. 3 illustrates an example of a hardware diagram of another embodiment of the system 100 for controlling fluorescent lamps 101. The embodiment in FIG. 3 includes multiple light fixtures 106 and corresponding light adapters 102. Each one of the light adapters 102 may be in communication with the engine 108 over a corresponding one of adapter lines 110. Alternatively or in addition, two or more of the light adapters 102 may be in communication with the engine 108 over one of the adapter lines 110. In one example, each one of the light adapters 102 may be powered by a DC signal generated by the engine 108 and received over the adapter line 110.

The engine 108 and the light fixtures 106 may receive the AC power signal 127 over an AC feed 310. Alternatively or in addition, the light fixtures 106 may be powered by the engine 108 over the adapter lines 110. During operation of the system 100, each one of the light adapters 102 may control the fluorescent lamps 101 included in one or more corresponding light fixtures 106.

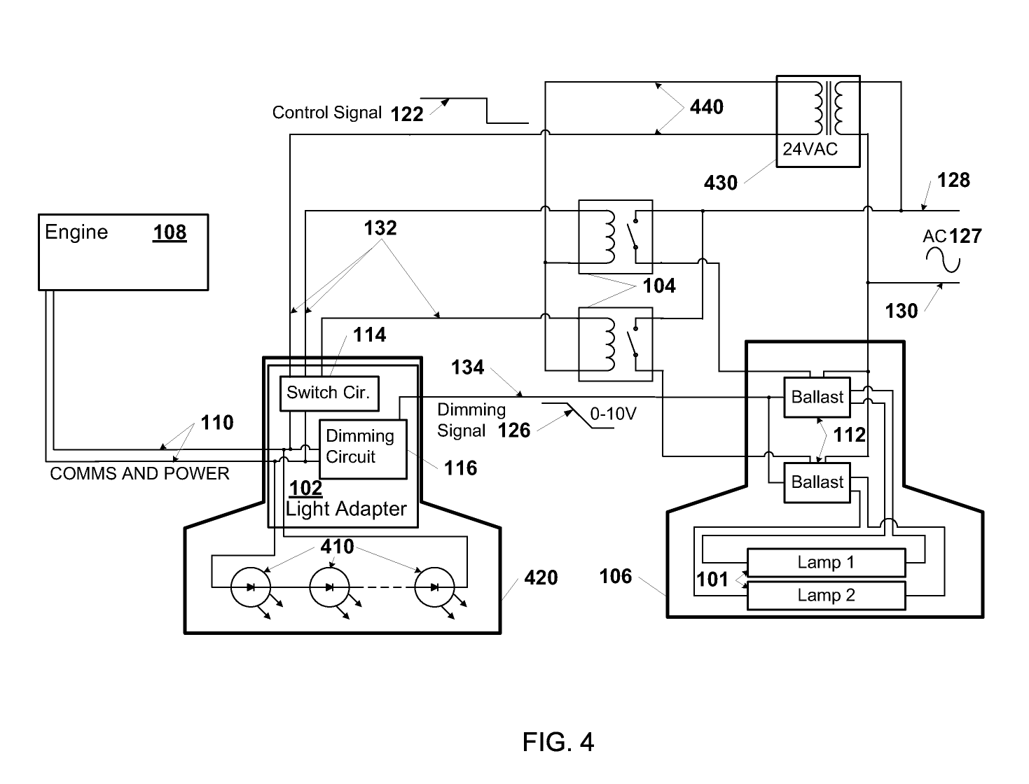

FIG. 4 illustrates an example of a hardware diagram of the system 100 for both controlling fluorescent lamps 101 in a first light fixture 106 and controlling LED (light emitting diode) lamps 410 in a second light fixture 420. The system 100 may include the light adapter 102, the first light fixture 106, the second light fixture 420, the switches 104, and a transformer 430. The light adapter 102 may be included in the second light fixture 420. Alternatively or in addition, the light adapter 102 may be included in the first light fixture 106 or neither of the light fixtures 106 and 420.

The LED lamps 410 may be powered by a signal received over two conductors included in the adapter line 110. For example, the engine 108 may generate a PWM DC signal on the adapter line 110. The LED lamps may be electrically coupled to the adapter line 110 to receive the PWM DC signal. The more power that the engine 108 generates on the adapter line 110, the more light the LED lamps 410 may emit. Conversely, the less power that the engine 108 generates on the adapter line 110, the less light that the LED lamps 410 may generate.

In one example, the dimming circuit 116 may average current in the PWM DC signal received on the adapter line 110 in order to generate the dimming signal 126 on the dimming signal line 134. In a second example, the dimming circuit 116 may read the desired light level as a value encoded in the PWM DC signal or using any other now known or later discovered communication technique.

The transformer 430 may transform the AC power signal 127 received on the live line 128 and the neutral line 130 into a lower voltage signal used to drive the control signals 122 of the switches 104. For example, the lower voltage signal may be a 24 volt AC signal. Lines 440 may be electrically coupled to output nodes of the transformer 430. One of the lines 440 electrically coupled to output nodes of the transformer 430 may be electrically coupled to the switches 104. Another one of the lines 440 electrically coupled to output nodes may be electrically coupled to the switch circuit 114. The switch circuit 114 may be electrically coupled to the switches 104, such that the switch circuit 114 may selectively provide the lower voltage signal as the control signals 122 to the switches 104. The transformer 430 may be included whether or not the system 100 includes the LED lamps 410. The switches 104 may be any type of switch including any type of relay. For example, the switches 104 may include a “dry contact” relay, which does not require a power source like the transformer 430. The “dry contact” relay includes a high impedance input that determines whether terminals of the high impedance input are shorted. Alternatively or in addition, the switches 104 may be powered from the transformer 430, the full line voltage, AC, DC, or any other power source. In the example illustrated in FIG. 4, when one of the switches 104 closes, the circuit is completed in a relay coil of the switch, which closes the contacts on the relay and energizes one or more ballasts 112.

The configuration illustrated in FIG. 4 may be useful for at least two reasons. First, the light adapter 102 may provide relatively high impedance on the adapter line 110 if the LED lamps 410 are not electrically coupled to the adapter line 110. Consequently, if the engine 108 is a current source, then the engine 108 may generate a relatively large voltage across the two conductors included in the line 110 where the LED lamps 410 are not electrically coupled to the adapter line 110. Alternatively, the light adapter 102 may include a clamp circuit to prevent a large voltage difference from being generated across the two conductors. While the voltage and current levels in the clamp circuit may be minimized to decrease unnecessary power consumption, the clamp circuit may be inherently inefficient. Current passing through the clamp circuit may be effectively wasted. In contrast, when the current passes through the LED lamps 410, the LED lamps 410 may produce useful light instead of the current being wasted.

Second, LED lamps 410 are increasingly replacing fluorescent lamps, but fluorescent lamps are still widely used. LED light fixtures are gaining acceptance as downlights, such as cans, wall washes, or other lighting fixture formats. Nevertheless, fluorescent light fixtures still dominate in configurations that use widely broadcast lighting, such as in commercial lighting, troffers, and other suitable form factors.

In the example illustrated in FIG. 4, the LED lamps 410 effectively operate as the clamp circuit as well as provide a useful light source. Furthermore, the light adapter 102 may vary the light generated by both the LED light lamps 410 and the fluorescent light lamps 101 in accordance with the desired light level 208.

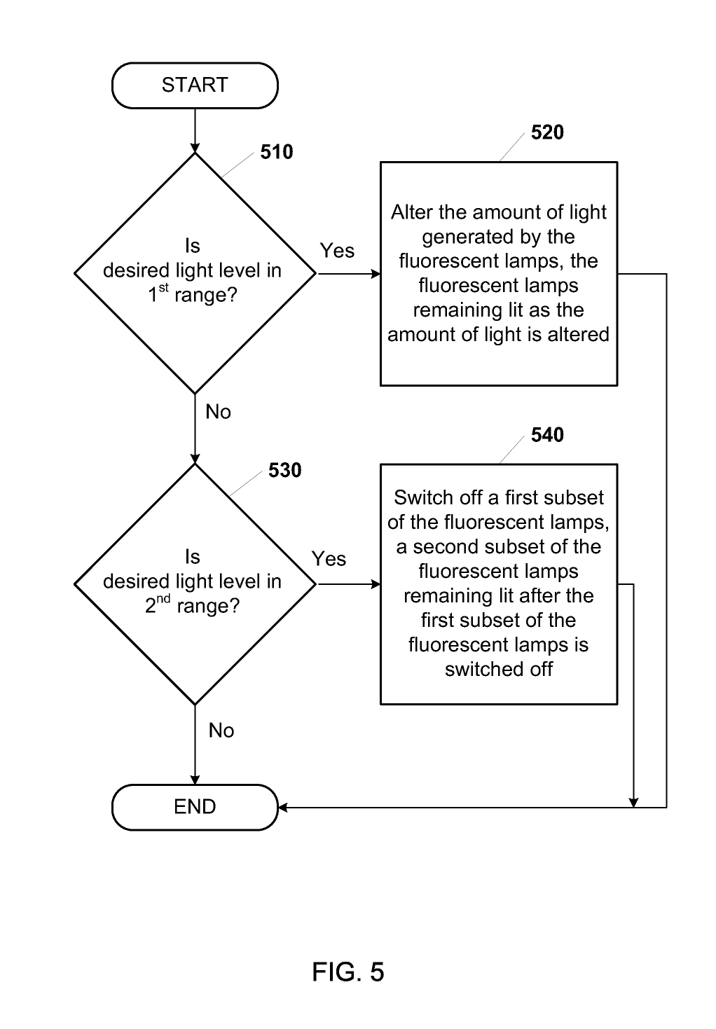

FIG. 5 illustrates an example flow diagram of the logic or method use of the system 100 for controlling fluorescent lamps 101. The flow may include additional, different, or fewer operations. For example, the logic may include receiving the desired light level 208. The operations may be executed in a different order than illustrated in FIG. 5.

The logic in the example illustrated in FIG. 5 may begin when the light adapter 102 and/or the engine 108 determines whether the desired light level 208 is in a first range of light level values (510). The range of light level values may be a single value, a set of distinct predetermined values, or any value between two predetermined values. For example, the range of light level values may be one of the desired light level ranges listed in Tables 1, 2, or 3. The range of light level values may be hard-coded. Alternatively or in addition, the light adapter 102 and/or the engine 108 may dynamically determined the range of light level values. For example, the range of light level values may be determined during calibration discussed above. Alternatively or in addition, the engine 108 may communicate the range of light level values to the light adapter 102.

In response to a determination that the desired light level 208 is in the first range of light level values, the light adapter 102 and/or the engine 108 may alter the amount of light generated by at least one of the fluorescent lamps 101, where the fluorescent lamps 101 remain lit as the amount of light generated by the fluorescent lamps 101 is altered (520). For example, the light adapter 102 and/or the engine 108 may transmit the dimming signal 126 over the dimming signal line 134 to one or more dimmable fluorescent lamp ballasts 112. Alternatively, the light adapter 102 and/or the engine 108 may continue to operate non-dimmable ballasts.

If the desired light level 208 is not in the first range of light level values, the light adapter 102 may determine whether the desired light level 208 is in a second range of light level values (530). The second range of light level values may indicate that less light is desired than indicated by the first range of light level values.

In response to a determination that the desired light level 208 is in the second range of light level values, the light adapter 102 may switch off a first subset of the fluorescent lamps 101, where a second subset of the fluorescent lamps 101 remain lit after the first subset of the fluorescent lamps 101 is switched off (540). For example, the light adapter 102 may transmit control signals 122 to the switches 104. A first one of the switches 104 may control the fluorescent lamps 101 in the first subset of the fluorescent lamps 101. A second one of the switches 104 may control the fluorescent lamps 101 in the second subset of the fluorescent lamps 101.

If the desired light level 208 is not in the second range of light level values, the light adapter 102 may determine whether the desired light level 208 is in a range of light level values different from the first and second ranges of light level values. Alternatively or in addition, the logic of the light adapter 102 in the example illustrated in FIG. 5 may end by waiting for a change in the desired light level 208.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable media, for example, secondary storage devices such as hard disks, floppy disks, and CD-ROMs; a signal received from a network; or other forms of ROM or RAM either currently known or later developed. Moreover, the functionality of any of the circuits is but one example of such functionality and any other configurations encompassing similar functionality are possible. For example, the dimming circuit 116 may operate as the switch circuit 114.

Furthermore, although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Data structures may be separately stored and managed, may be incorporated into a single memory or database, may be distributed, or may be logically and physically organized in many different ways. Programs may be parts of a single program, separate programs, or distributed across several memories and processors.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A system for controlling an amount of light generated by a plurality of fluorescent lamps based on a desired light level comprising:
a dimming circuit configured to vary the amount of light generated by at least one of the fluorescent lamps based on the desired light level in response to a determination that the desired light level is in a first range of light level values, the at least one of the fluorescent lamps being lit as the amount of light is varied; and
a switch circuit configured to switch off a first subset of the fluorescent lamps while a second subset of the fluorescent lamps remains lit in response to a determination that the desired light level is in a second range of light level values, the second range of light level values indicating less light is desired than indicated by the first range of light level values.

2. The system of claim 1, wherein the dimming circuit provides a dimming signal to at least one dimmable fluorescent lamp ballast to vary the amount of light generated in response to the determination the desired light level is in the first range of light level values, the at least one dimmable fluorescent lamp ballast electrically coupled to the at least one of the fluorescent lamps.

3. The system of claim 1, wherein the switch circuit is configured to switch on the first subset of the fluorescent lamps and switch off the second subset of the fluorescent lamps in response to a determination the desired light level is in a third range of light level values, the third range of light level values indicating less light is desired than the second range of light level values indicate.

4. The system of claim 1, wherein the first subset of the fluorescent lamps includes a different number of the fluorescent lamps than the second subset of the fluorescent lamps.

5. The system of claim 1 further comprising a light adapter, the light adapter comprising the dimming circuit, the switch circuit, and a communications circuit, the communications circuit configured to receive the desired light level over an adapter line electrically coupled to the light adapter.

6. The system of claim 5 further comprising an engine circuit electrically coupled to the adapter line, the engine circuit configured to provide a pulse width modulated signal to the light adapter over the adapter line, a duty cycle of the pulse width modulated signal corresponding to the desired light level.

7. The system of claim 5, further comprising a light emitting diode light fixture electrically coupled to the adapter line, the light emitting diode light fixture powered by a signal received over the adapter line.

8. A light adapter for controlling an amount of light generated by a plurality of fluorescent lamps based on a desired light level comprising:
a dimming circuit configured to adjust the amount of light generated by at least one of fluorescent lamps in accordance with the desired light level in response to a determination the desired light level is in a first range of light level values, the at least one of the fluorescent lamps being lit as the amount of light is varied; and
a switch circuit configured to switch off a first subset of the fluorescent lamps and switch on a second subset of the fluorescent lamps in response to a determination the desired light level is in a second range of light level values.

9. The light adapter of claim 8, wherein the dimming circuit provides a dimming signal to at least one dimmable fluorescent lamp ballast to adjust the amount of light generated in response to the determination the desired light level is in the first range of light level values, the at least one dimmable fluorescent lamp ballast electrically coupled to the at least one of the fluorescent lamps.

10. The light adapter of claim 8, wherein the first subset of the fluorescent lamps includes a different number of the fluorescent lamps than the second subset of the fluorescent lamps

11. The light adapter of claim 8, further comprising a communications circuit configured to receive a pulse width modulated signal, a duty cycle of the pulse width modulated signal indicating the desired light level.

12. The light adapter of claim 11, wherein the light adapter is powered by the pulse width modulated signal.

13. The light adapter of claim 8, wherein the switch circuit is configured to switch off all of the fluorescent lamps in response to a determination the desired light level indicates less light is desired than values in the second range of light level values indicate.

14. The light adapter of claim 8, wherein the switch circuit comprises a processor and a memory, the processor being in communication with the memory, and the memory comprising instructions executable with the processor to determine whether the desired light level is in the first range of light level values.

15. A method to control an amount of light generated by a plurality of fluorescent lamps based on a light level indicator, the method comprising:
altering the amount of light generated by at least one of the fluorescent lamps when the light level indicator is in a first range of light level values, the at least one of the fluorescent lamps remaining lit as the amount of light is altered; and
switching off a first subset of the fluorescent lamps by a light adapter when the light level indicator is in a second range of light level values, a second subset of the fluorescent lamps remaining lit after the first subset of the fluorescent lamps is switched off, the second range of light level values indicating less light than indicated by the first range of light level values.

16. The method of claim 15, wherein altering the amount of light generated includes transmitting a dimming signal to at least one dimmable fluorescent ballast electrically coupled to the at least one of the fluorescent lamps.

17. The method of claim 15, further comprising receiving the light level indicator at the light adapter over an adapter line.

18. The method of claim 15, wherein switching off the first subset of the fluorescent lamps at the light adapter comprises:
generating a comparison signal by averaging a power signal received over an adapter line;
generating a control signal by comparing the comparison signal with a reference voltage; and
providing the control signal to at least one switch configured to stop and start a flow of current through the first subset of the fluorescent lamps.

19. A system for controlling an amount of light generated by a plurality of fluorescent lamps based on a desired light level comprising:
a light adapter powered by a pulse width modulated signal received from an engine circuit over an adapter line, the desired light level indicated by a duty cycle of the pulse width modulated signal;
a first switch configured to control whether at least a first one of the fluorescent lamps is on; and
a second switch configured to control whether at least a second one of the fluorescent lamps is on, wherein the light adapter comprises a switch circuit in communication with the first switch and the second switch, the switch circuit configured to:
switch the first switch off and the second switch on in response to a determination the desired light level is less than a threshold light level; and
switch the first switch on and the second switch on in response to a determination the desired light level is not less than the threshold light level.

20. The system of claim 19, wherein the threshold light level is a first threshold light level that is greater than a second threshold light level, wherein the switch circuit is further configured to switch the first switch on and the second switch off in response to a determination the desired light level is less than the second threshold light level.

21. The system of claim 19, wherein the light adapter comprises a dimming circuit configured to dim at least one of fluorescent lamps in accordance with the desired light level in response to the determination that the desired light level is not less than the threshold light level, wherein the at least one of the fluorescent lamps remains lit when dimmed.
